(19) United States
(12) Patent Application Publication
(10) Pub. No.: US 2018/0060863 A1
(43) Pub. Date: Mar. 1, 2018

(54) METHOD AND SYSTEM FOR PAYMENT STATUS VERIFICATION

(71) Applicant: MasterCard Asia/Pacific Pte. Ltd., Singapore (SG)

(72) Inventors: Sunitha Miryala, Singapore (SG); Kshama Jha, Singapore (SG); Choon Meng Low, Singapore (SG)

(21) Appl. No.: 15/662,972

(22) Filed: Jul. 28, 2017

(30) Foreign Application Priority Data
Aug. 23, 2016 (SG) 10201607014S

(51) Int. Cl. G06Q 20/40; G06Q 20/20; G06K 19/06; G06K 19/077

(52) U.S. Cl. CPC G06Q 20/401; G06K 19/07758; G06K 19/06028; G06Q 20/209

(57) ABSTRACT

A computer-implemented method for payment status verification of one or more selected products, the method comprising the steps of: receiving a unique transaction code by a checkout module, the unique transaction code being associated with one or more paid products; retrieving, from a database, a product identifier of each of the one or more paid products based on the received unique transaction code; receiving, by the checkout module, at least one product identifier of the one or more selected products; and verifying, using a verification module which is in communication with the checkout module, the payment status of the one or more selected products based on a comparison of the at least one received product identifier of the one or more selected products with the retrieved product identifier of the one or more paid products.

### CROSS-REFERENCE TO RELATED APPLICATION

This application is a U.S. National Stage filing under 35 U.S.C. § 119, based on and claiming benefit of and priority to SG Patent Application No. 10201607014S filed Aug. 23, 2016.

### FIELD OF INVENTION

The present invention relates broadly, but not exclusively, to a method and a system for payment status verification.

### BACKGROUND

In a retail store, customers make payment for items that they wish to purchase at a checkout counter. Conventionally, the task of processing the items to be purchased and collecting payment is handled by a cashier at a cash register. The queue of the customers waiting to make payment at the cash register can be long at times, especially during peak periods.

While the store owner can address the problem of long queues by setting up more cash registers in the store, this may not always be feasible. For example, increasing the number of cash registers in the store will increase the headcount of the employees in the store. Thus, the labour cost of the business increases. Also, the store may have a limited store area, thereby limiting the number of cash registers that can be set up in the store.

Currently, some of retail stores use self-checkout counters to facilitate payment. By allowing the customers to process their own transactions, the checkout rate can be increased without significantly adding headcount in the store. However, there are some drawbacks associated with self-checkout counters. For example, a customer may intentionally or unintentionally not make payment for all the checkout items. To prevent losses resulting from this, the store owner may have to deploy some auditing measures at the self-checkout counter.

A need therefore exists to provide a method and system for payment status verification that addresses at least one of the problems above or to provide a useful alternative.

### SUMMARY

According to a first aspect of the present invention, there is provided a computer-implemented method for payment status verification of one or more selected products, the method comprising the steps of: receiving a unique transaction code by a checkout module, the unique transaction code being associated with one or more paid products; retrieving, from a database, a product identifier of each of the one or more paid products based on the received unique transaction code; receiving, by the checkout module, at least one product identifier of the one or more selected products; and verifying, using a verification module which is in communication with the checkout module, the payment status of the one or more selected products based on a comparison of the at least one received product identifier of the one or more selected products with the retrieved product identifier of the one or more paid products.

The step of receiving the unique transaction code may comprise reading the unique transaction code on a payment receipt that is associated with a payment transaction for the one or more paid products.

The payment receipt may be displayed on a display module of a user mobile device.

Upon authorization of the payment transaction for the one or more paid products, the method may comprise the steps of:

generating the unique transaction code associated with the one or more paid products; and

encoding the generated unique transaction code on a barcode on the payment receipt.

The step of receiving the at least one product identifier of the one or more selected products may comprise obtaining machine-readable data associated with each of the one or more selected products using a data reader of the checkout module.

The machine-readable data may be stored in a radio frequency identification (RFID) tag attached to each of the one or more selected products.

The product identifier may be unique to each of the one or more selected products.

The method may further comprise the steps of:
receiving, by the checkout module, a timestamp associated with the payment transaction for the one or more paid products;
determining, by the verification module, a validity of the unique transaction code based on the timestamp;
upon a positive determination, verifying the payment status of the one or more selected products.

The method may further comprise the step of transmitting the payment status of the one or more selected products to the checkout module.

According to a second aspect of the present invention, there is provided a system for payment status verification of one or more selected products, comprising:
a verification module;
a database in communication with the verification module; and
a checkout module in communication with the verification module,
wherein the checkout module is configured to:
receive a unique transaction code that is associated with one or more paid products; and
receive at least one product identifier of the one or more selected products, and wherein the verification module is configured to:
retrieve, from the database, a product identifier of each of the one or more paid products based on the unique transaction code received from the checkout module;
verify the payment status of the one or more selected products based on a comparison of the at least one product identifier of the one or more selected products received from the checkout module with the product identifier of the one or more paid products retrieved from the database.

The checkout module may further be configured to receive a timestamp associated with the payment transaction for the one or more paid products; and wherein the verification module may further be configured to determine a validity of the unique transaction code based on the timestamp.

The verification module may further be configured to transmit the payment status of the one or more selected products to the checkout module.

According to a third aspect of the present invention, there is provided a computer-implemented method for payment status verification facilitation of one or more selected products, the method comprising the steps of:
processing, by a payment module, a transaction for payment of one or more products, each of the one or more products having a product identifier associated therewith;
generating, by the payment module, a unique transaction code corresponding to the transaction;
storing, into a database, the unique transaction code associated with each product identifier of the one or more products; and
outputting the unique transaction code for payment status verification of the one or more selected products.

### BRIEF DESCRIPTION OF THE DRAWINGS

Embodiments of the invention are provided by way of example only, and will be better understood and readily apparent to one of ordinary skill in the art from the following written description, read in conjunction with the drawings, in which:

FIG. 1 shows a flow chart illustrating a method for payment status verification of one or more selected products according to an example embodiment.

FIG. 2 shows a schematic diagram of a system for payment status verification of one or more selected products according to an example embodiment.

FIG. 3 shows a schematic diagram illustrating a computer suitable for implementing the method and system of the example embodiments.

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “obtaining”, “estimating”, “assigning”, “creating”, “predicting”, “capturing”, “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, and/or computers.

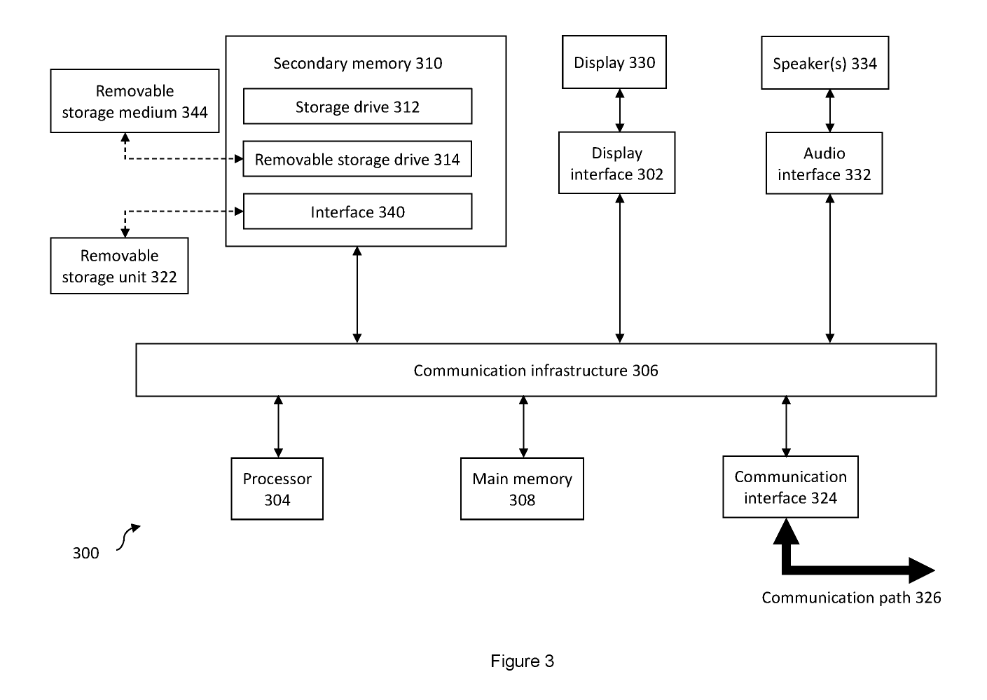

As used herein, the terms “module” and “database” refer to a single computing device or a plurality of interconnected computing devices which operate together to perform a particular function. That is, the “module” and “database” may be contained within a single hardware unit or be distributed among several or many different hardware units. An exemplary computing device which may be operated as a “module” and “database” is described below with reference to FIG. 3.

In the following description, the term “paid products” refers to items or products which customers have paid for in a payment transaction. The payment transaction can be processed at a point of sale (POS) terminal or via an online payment system, e.g. when making payment at a merchant's website. Once payment is made, the customers receive a payment receipt for the payment transaction. The term “selected products” refers to the items or products which the customers pick up from the store after the payment transaction. In the following description, the embodiments are mainly related to payment transactions processed at the POS terminal. Specifically, the customers enter the store and make payment at the POS terminal at a self-checkout counter. The customers then pick up the selected products from the store and proceed to an exit counter for payment status verification of the selected products, before leaving the store. It should be noted that payment transactions via the online payment system is also possible in other implementations.

The POS terminal includes at least one card acceptance component, such as a magnetic stripe reader, EMV chip reader or contactless (NFC) reader, for retrieving payment credentials from a physical payment card or other device capable of storing and/or retrieving payment credentials, such as a contactless fob or sticker, or a mobile computing device (such as a smartphone) which makes the payment credentials accessible to the POS terminal via a wireless communications channel such as NFC. In a mobile computing device, the payment credentials may be stored in a secure element (SE), or may be made available via host card emulation (HCE), for example. Typically, the POS terminal is integrated with or communicatively coupled with a retail point of sale system which comprises hardware and software components for maintaining details of products sold by the store, historical transaction details, customer loyalty and rewards data, and so on.

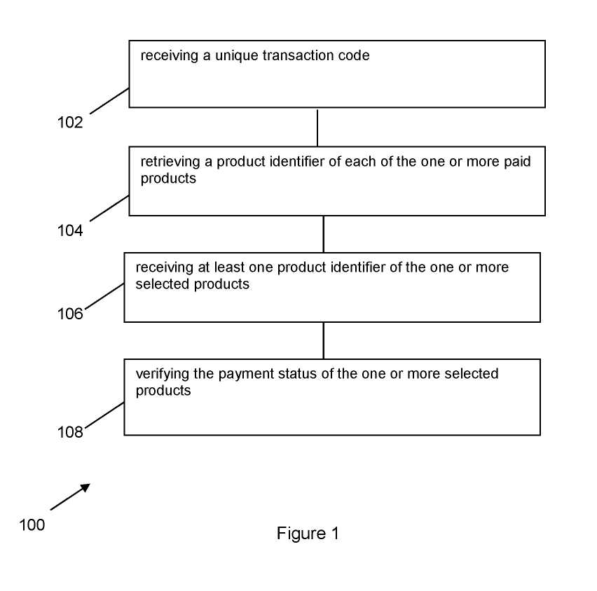

FIG. 1 shows a flow chart illustrating a method for payment status verification of one or more selected products according to an example embodiment. At step 102, a checkout module receives a unique transaction code. The unique transaction code is associated with one or more paid products.

A payment transaction is processed by a payment module for authorising the transaction. The payment module may be administered by a financial organisation that facilitates a payment transaction. The unique transaction code is generated by the payment module upon the authorization of the payment transaction. The unique transaction code is stored in a database, together with product identifiers of the paid products. The product identifier can be a stock-keeping unit (SKU) that can be used to identify a product type in the store. The product identifier is encoded on a tag that is attached to the product or to a packaging of the product. The encoded data is machine-readable for easy access by a data reader that is coupled to the self-checkout counter or to the checkout module. Thus, the unique transaction code and the product identifiers of the paid products stored in the database can be retrieved and used at a later time to identify the paid products in the payment transaction. Both the unique transaction code and the product identifier can be a string of alphabets or numerals, or a combination of both.

In an embodiment, the unique transaction code is provided on a payment receipt that is generated for the payment transaction. For example, the unique transaction code is encoded on a barcode and the barcode is subsequently printed on the payment receipt generated by the POS terminal after the payment transaction is authorised. The payment receipt can be a paper receipt or a digital receipt that is displayed on a display module of a user mobile device. Further, the barcode is either a one-dimensional (such as Universal Product Code) or two-dimensional code (such as Quick Response code).

The “checkout module” is configured to act as an intermediary between a user and a verification module. In an embodiment, the checkout module includes a barcode reader that can capture the barcode that is placed within range of the barcode reader and transmit the capture information to the verification module. The checkout module further includes a display screen that is configured to display information received from the verification module to the user.

As described above, the unique transaction code is encoded on a barcode. Thus, at step 102, the customer or a store attendant uses the barcode reader of the checkout module to read the unique transaction code on the payment receipt at the exit counter. Upon receiving the unique transaction code, the checkout module transmits the unique transaction code to the verification module. The checkout module may receive the unique transaction code from the customer or store attendant via other electronic user input devices, such as a touchscreen, a keyboard etc.

The verification module refers to a computer system that is configured to analyse the information received from the checkout module and the database. At step 104, the verification module receives the unique transaction code from the checkout module. The verification module transmits a request, including the unique transaction code, to the database to retrieve the product identifier of each of the one or more paid products based on the received unique transaction code.

In an embodiment, the product identifier of a product is encoded on a barcode which is printed on the product. In another embodiment, the product identifier is stored in a radio-frequency identification (RFID) tag which is attached to the product. The barcode and RFID tag can also be printed or attached on a packaging of the product, instead of the product itself.

For example, the unique transaction code is associated with the product identifiers of five items and this information is stored in the database after the payment transaction for the five items is authorised. Upon receiving the unique transaction code, the verification module retrieves the product identifiers of each of the five items from the database. In an embodiment, the product identifiers retrieved by the verification module are transmitted to the checkout module for display on the display screen of the checkout module, together with the details of the paid product, e.g. the product name, the product price etc.

At step 106, at least one product identifier of the one or more selected products is received by the checkout module. The checkout module includes a data reader for obtaining the product identifiers of the selected products. In an embodiment, the barcode of each of the selected products are scanned by the customer or the store attendant using a barcode reader. In another embodiment, each of the selected products with their respective RFID tags are placed in proximity of an RFID reader. The product identifiers that are read by the barcode reader or RFID reader are then displayed on the display screen of the checkout module, together with the details of the selected products. Upon receiving the product identifiers of the selected products at step 106, the checkout module transmits the received product identifiers to the verification module.

At step 108, the payment status of the one or more selected products is verified based on a comparison of the at least one product identifier of the one or more selected products (received at step 106) with the product identifier of the one or more paid products (retrieved at step 104). The term “payment status” includes information on whether or not the selected products have been paid for. The payment status can be represented by various pairs of positive and negative expressions, e.g. valid and invalid, positive and negative, paid and unpaid, match and mismatch.

In an embodiment, the product identifier is unique to each of the products in the store. In other words, none of the products in the store have the same product identifier, even if the products are identical (e.g. two identical boxes of cereal). For each of the product identifier received at step 106, the verification module searches for an identical product identifier among those that have been retrieved at step 104. If an identical product identifier is found, the selected product is considered a paid item. Otherwise, the selected product is considered an unpaid item. The checkout module displays the information of the payment status of the selected products on the display screen. For example, the display screen indicates that the payment status as “valid” if a selected product is found to be paid and “invalid” if a selected product is found to be unpaid. An alarm may also be activated to alert the store attendant if there is any selected product that is found to be an unpaid item.

In another embodiment, the product identifier is the same for products with identical attributes. In this case, identical products (e.g. two identical boxes of cereal) in the store may have the same product identifier. The verification module matches each of the product identifier received at step 106 with an identical product identifier among those that have been retrieved at step 104, provided that no product identifier is being matched with more than one corresponding identical product identifier. For example, if the verification module receives three identical product identifiers (e.g. A1234) at step 106, the verification module is configured to look for three product identifiers “A1234” among those that are retrieved at step 104, before verifying that the products are paid items. This may prevent the scenarios where the customer paid for a product at a certain quantity (e.g. three cereal boxes) and picked up that product in a larger quantity (e.g. five boxes of cereal) or in a smaller quantity (e.g. two boxes of cereal).

As described above with respect to step 102, the checkout module receives the unique transaction code that is associated with the one or more paid products. In an embodiment, the checkout module further receives a timestamp associated with the payment transaction for the one or more paid products. For example, the timestamp indicates the date and/or the time at which the payment transaction is authorised.

The timestamp can be encoded on the same barcode as the unique transaction code, which is then printed on the payment receipt generated by the POS terminal at the checkout counter after the payment transaction is authorised. The timestamp is sent to the verification module for determining a validity of the unique transaction code.

In an embodiment, a merchant can define a validity period of the unique transaction code by setting a predetermined validity period. The predetermined validity period provides a time period that the unique transaction code is considered valid. The predetermined validity period depends on various factors such as the size and nature of the premises which may affect time spent by customers in the store. For example, the predetermined validity period can be 15 minutes for a small convenience store while the predetermined validity period can be 2 hours for a supermarket. Using the example of the convenience store, if a customer makes a payment transaction at the POS terminal at 10 a.m. on 10 Jul. 2016, a timestamp (e.g. 1000-10072016) is generated at the checkout counter. At the exit counter, the verification module receives the timestamp for payment status verification. The verification module calculates a time period between the time indicated by the timestamp (i.e. 10 a.m.) and a current time, i.e. a time at which the customer reaches the exit counter. The calculated time period is compared with the predetermined validity period (i.e. 15 minutes) for determining the validity of the unique transaction code. If the calculated time is shorter than the predetermined validity period (i.e. less than 15 minutes), the unique transaction code is considered a valid unique transaction code, and vice versa.

The checkout module displays the result of the comparison on the display screen and an alarm may be activated to alert the store attendant if the unique transaction code is not valid. The verification module proceeds with verifying the payment status of the one or more selected products upon a positive determination of a valid unique transaction code.

The determination of the validity of a unique transaction code may prevent a scenario where a unique transaction code received by the checkout module at step 102 is long overdue and may prevent customers from repeatedly using the same unique transaction code at the exit counter.

As described above, a unique transaction code generated at the POS terminal can be used to verify the payment status of the selected products at the exit counter of the store. Therefore, self-checkout systems in the store can be supplemented with the payment status verification of the selected product as an auditing measure to improve the security and reduce losses in the store. The payment status verification may also improve customer satisfaction by notifying the customers if they have selected a wrong product in the store upon making the payment.

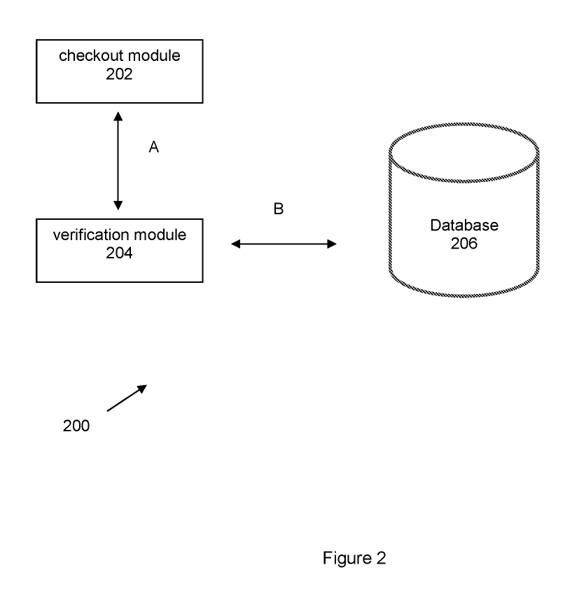

FIG. 2 shows a schematic diagram of a system for payment status verification of one or more selected products according to an example embodiment. The system includes a checkout module 202, a verification module 204 and a database 206. Both the checkout module 202 and the database 206 are in communication with the verification module 204.

The checkout module 202 includes a data reader, such as a barcode reader or an RFID reader, that is configured to receive a unique transaction code which is associated with one or more paid products. The unique transaction code is generated upon the authorization of a payment transaction and is stored in the database 206, together with the product identifiers of the paid products. The product identifier can be a stock-keeping unit (SKU) that can be used to identify a product type in the store. Thus, the unique transaction code and the product identifiers of the paid products stored in the database can be retrieved and used at a later time to identify the paid products in the payment transaction completed at the POS terminal. In an embodiment, the checkout module is further configured to receive a timestamp associated with the payment transaction for the one or more paid products.

Upon receiving the unique transaction code, the checkout module 202 transmits the unique transaction code to the verification module 204. The data reader is also configured to receive at least one product identifier of the one or more selected products. The checkout module 202 also includes a display screen that is configured to display information received by the checkout module 202.

The verification module 204 is configured to retrieve, from the database, a product identifier of each of the one or more paid products based on the unique transaction code received from the checkout module 202. The verification module 204 is further configured to verify the payment status of the one or more selected products based on a comparison of the at least one product identifier of the one or more selected products received from the checkout module 202 with the product identifier of the one or more paid products retrieved from the database 206. Details of the verification method have been provided above.

In an embodiment, the verification module 204 is further configured to determine a validity of the unique transaction code based on the timestamp. The verification module is configured to proceed with verifying the payment status of the one or more selected products upon a positive determination of a valid unique transaction code. In another embodiment, the verification module is further configured to transmit the payment status of the one or more selected products to the checkout module.

FIG. 3 depicts an exemplary computing device 300, hereinafter interchangeably referred to as a computer system 300, where one or more such computing devices 300 may be used in payment status verification (e.g. to realise the checkout module 202 and/or the verification module 204). The following description of the computing device 300 is provided by way of example only and is not intended to be limiting.

As shown in FIG. 3, the example computing device 300 includes a processor 304 for executing software routines. Although a single processor is shown for the sake of clarity, the computing device 300 may also include a multi-processor system. The processor 304 is connected to a communication infrastructure 306 for communication with other components of the computing device 300. The communication infrastructure 306 may include, for example, a communications bus, cross-bar, or network.

The software routines, or computer programs, may be stored in memory and be executable by the processor to cause the computer system 300 to: (A) receive a unique transaction code, the unique transaction code being associated with one or more paid products; (B) retrieve a product identifier of each of the one or more paid products based on the received unique transaction code; (C) receive at least one product identifier of the one or more selected products; and (D) verify the payment status of the one or more selected products based on a comparison of the at least one received product identifier of the one or more selected products with the retrieved product identifier of the one or more paid products. The software routines or computer programs may also comprise steps executable by the processor to cause the computer system 300 to perform the various other analytical steps (e.g. generating the unique transaction code associated with the one or more paid products, encoding the generated unique transaction code on a barcode on the payment receipt and transmitting the payment status of the one or more selected products).

The computing device 300 further includes a main memory 308, such as a random access memory (RAM), and a secondary memory 310. The secondary memory 310 may include, for example, a hard disk drive 312 and/or a removable storage drive 314, which may include a floppy disk drive, a magnetic tape drive, an optical disk drive, or the like. The removable storage drive 314 reads from and/or writes to a removable storage unit 318 in a well-known manner. The removable storage unit 318 may include a floppy disk, magnetic tape, optical disk, or the like, which is read by and written to by removable storage drive 314. As will be appreciated by persons skilled in the relevant art(s), the removable storage unit 318 includes a computer readable storage medium having stored therein computer executable program code instructions and/or data.

In an alternative implementation, the secondary memory 310 may additionally or alternatively include other similar means for allowing computer programs or other instructions to be loaded into the computing device 300. Such means can include, for example, a removable storage unit 322 and an interface 320. Examples of a removable storage unit 322 and interface 320 include a program cartridge and cartridge interface (such as that found in video game console devices), a removable memory chip (such as an EPROM or PROM) and associated socket, and other removable storage units 322 and interfaces 320 which allow software and data to be transferred from the removable storage unit 322 to the computer system 300.

The computing device 300 also includes at least one communication interface 324. The communication interface 324 allows software and data to be transferred between computing device 300 and external devices via a communication path 326. In various embodiments, the communication interface 324 permits data to be transferred between the computing device 300 and a data communication network, such as a public data or private data communication network. The communication interface 324 may be used to exchange data between different computing devices 300 which such computing devices 300 form part an interconnected computer network. Examples of a communication interface 324 can include a modem, a network interface (such as an Ethernet card), a communication port, an antenna with associated circuitry and the like. The communication interface 324 may be wired or may be wireless. Software and data transferred via the communication interface 324 are in the form of signals which can be electronic, electromagnetic, optical, or other signals capable of being received by communication interface 324. These signals are provided to the communication interface via the communication path 326.

As shown in FIG. 3, the computing device 300 further includes a display interface 302 which performs operations for rendering images to an associated display 330 and an audio interface 332 for performing operations for playing audio content via associated speaker(s) 334.

As used herein, the term “computer program product” may refer, in part, to removable storage unit 318, removable storage unit 322, a hard disk installed in hard disk drive 312, or a carrier wave carrying software over communication path 326 (wireless link or cable) to communication interface 324. Computer readable storage media refers to any non-transitory tangible storage medium that provides recorded instructions and/or data to the computing device 300 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computing device 300. Examples of transitory or non-tangible computer readable transmission media that may also participate in the provision of software, application programs, instructions and/or data to the computing device 300 include radio or infra-red transmission channels as well as a network connection to another computer or networked device, and the Internet or Intranets including e-mail transmissions and information recorded on Websites and the like.

The computer program product may thus comprise memory in which is stored instructions executable by the processor to cause the computer system 300 to: (A) receive a unique transaction code, the unique transaction code being associated with one or more paid products; (B) retrieve a product identifier of each of the one or more paid products based on the received unique transaction code; (C) receive at least one product identifier of the one or more selected products; and (D) verify the payment status of the one or more selected products based on a comparison of the at least one received product identifier of the one or more selected products with the retrieved product identifier of the one or more paid products. The computer program product may also comprise steps which, when executed by the processor, cause the computer system 300 to perform the various other analytical steps (e.g. generating the unique transaction code associated with the one or more paid products, encoding the generated unique transaction code on a barcode on the payment receipt and transmitting the payment status of the one or more selected products).

The computer programs (also called computer program code) are stored in main memory 308 and/or secondary memory 310. Computer programs can also be received via the communication interface 324. Such computer programs, when executed, enable the computing device 300 to perform one or more features of embodiments discussed herein. In various embodiments, the computer programs, when executed, enable the processor 304 to perform features of the above-described embodiments. Accordingly, such computer programs represent controllers of the computer system 300.

Software may be stored in a computer program product and loaded into the computing device 300 using the removable storage drive 314, the hard disk drive 312, or the interface 320. Alternatively, the computer program product may be downloaded to the computer system 300 over the communications path 326. The software, when executed by the processor 304, causes the computing device 300 to perform functions of embodiments described herein.

It is to be understood that the embodiment of FIG. 3 is presented merely by way of example. Therefore, in some embodiments one or more features of the computing device 300 may be omitted. Also, in some embodiments, one or more features of the computing device 300 may be combined together. Additionally, in some embodiments, one or more features of the computing device 300 may be split into one or more component parts.

In an implementation, the checkout module 202 and/or the verification module 204 may be generally described as a physical device comprising at least one processor and at least one memory including computer program code. The at least one memory and the computer program code are configured to, with the at least one processor, cause the physical device to perform the requisite operations.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A computer-implemented method for payment status verification of one or more selected products, the method comprising the steps of:
receiving a unique transaction code by a checkout module, the unique transaction code being associated with one or more paid products;
retrieving, from a database, a product identifier of each of the one or more paid products based on the received unique transaction code;
receiving, by the checkout module, at least one product identifier of the one or more selected products; and
verifying, using a verification module which is in communication with the checkout module, the payment status of the one or more selected products based on a comparison of the at least one received product identifier of the one or more selected products with the retrieved product identifier of the one or more paid products.

2. The method as claimed in claim 1, wherein receiving the unique transaction code comprises reading the unique transaction code on a payment receipt that is associated with a payment transaction for the one or more paid products.

3. The method as claimed in claim 2, wherein the payment receipt is displayed on a display module of a user mobile device.

4. The method as claimed in claim 2, wherein upon authorization of the payment transaction for the one or more paid products, the method comprises the steps of:
generating the unique transaction code associated with the one or more paid products; and
encoding the generated unique transaction code on a barcode on the payment receipt.

5. The method as claimed in claim 1, wherein receiving the at least one product identifier of the one or more selected products comprises obtaining machine-readable data associated with each of the one or more selected products using a data reader of the checkout module.

6. The method as claimed in claim 5, wherein the machine-readable data is stored in a radio frequency identification (RFID) tag attached to each of the one or more selected products.

7. The method as claimed in claim 1, wherein the product identifier is unique to each of the one or more selected products.

8. The method as claimed in claim 1, further comprising the steps of:
receiving, by the checkout module, a timestamp associated with the payment transaction for the one or more paid products;
determining, by the verification module, a validity of the unique transaction code based on the timestamp;
upon a positive determination, verifying the payment status of the one or more selected products.

9. The method as claimed claim 1, further comprising the step of transmitting the payment status of the one or more selected products to the checkout module.

10. A system for payment status verification of one or more selected products, comprising:
a verification module;
a database in communication with the verification module; and
a checkout module in communication with the verification module, wherein the checkout module is configured to:
receive a unique transaction code that is associated with one or more paid products; and
receive at least one product identifier of the one or more selected products,
and wherein the verification module is configured to:
retrieve, from the database, a product identifier of each of the one or more paid products based on the unique transaction code received from the checkout module;
verify the payment status of the one or more selected products based on a comparison of the at least one product identifier of the one or more selected products received from the checkout module with the product identifier of the one or more paid products retrieved from the database.

11. The system as claimed in claim 10, wherein the checkout module is further configured to receive a timestamp associated with the payment transaction for the one or more paid products; and wherein the verification module is further configured to determine a validity of the unique transaction code based on the timestamp.

12. The system as claimed in claim 10, wherein the verification module is further configured to transmit the payment status of the one or more selected products to the checkout module.

13. A computer-implemented method for payment status verification facilitation of one or more selected products, the method comprising the steps of:
processing, by a payment module, a transaction for payment of one or more products, each of the one or more products having a product identifier associated therewith;
generating, by the payment module, a unique transaction code corresponding to the transaction;
storing, into a database, the unique transaction code associated with each product identifier of the one or more products; and
outputting the unique transaction code for payment status verification of the one or more selected products.
